(19) United States
(12) Patent Application Publication
(10) Pub. No.: US 2017/0372225 A1
(43) Pub. Date: Dec. 28, 2017

(54) TARGETING CONTENT TO UNDERPERFORMING USERS IN CLUSTERS

(71) Applicant: Microsoft Technology Licensing, LLC, Redmond, WA (US)

(72) Inventor: Adalberto Foresti, Kirkland, WA (US)

(73) Assignee: Microsoft Technology Licensing, LLC, Redmond, WA (US)

(21) Appl. No.: 15/195,944

(22) Filed: Jun. 28, 2016

(51) Int. Cl. G06N 99/00; G06N 3/08; G06N 3/04; G06N 7/00; G06F 17/30

(52) U.S. Cl. CPC G06N 99/005; G06N 7/005; G06F 17/30598; G06N 3/04; G06N 3/08

(57) ABSTRACT

A method is provided that includes obtaining individual behavior data of a target user and crowd behavior data of other users, and executing a machine learning algorithm to determine performance benchmarks for tasks based on the crowd behavior data. The method further includes aggregating the other users into a plurality of user clusters, classifying the target user into one of the clusters, identifying one or more focus features of the target user that underperform at least one benchmark of the one or more features of the plurality of users in the user cluster to which the target user is classified, identify targeted content associated with the one or more tasks or chains of tasks based on the one or more identified features of the target user, and deliver the targeted content via the computing device.

### BACKGROUND

Computer applications, including computer games, are played by users with varying skill levels ranging from novice to expert. Most players may never achieve the skill level of an expert, but may still have potential to improve their performance by focusing on specific tasks or subtasks in the application where the player has room for improvement. In addition to skill level, players also differentiate themselves based on specific features and metrics. For example, players may differ in the style of their gameplay, reaction times, speed, and accuracy. Casual players may have an approach to finishing the game that differs from more serious players, and game strategies vary widely between offensive players and defensive players, and between aggressive players and passive players.

Many existing computer applications include an in-app tutorial or hint system to help users improve their performance. However, current tutorials require the user to realize that the user needs help, and to open the tutorial to seek help. Further, the tutorial's or hint system's level may be too advanced or too simple for the user, either taking the fun out of the game, or failing to decrease the user's frustration with the game. Finally, tutorials and hint systems are limited to the ideas that the developers endow them with, and thus gaps in a user's comprehension or skill that developers did not predict would occur when developing the game are unlikely to be addressed by such systems.

### SUMMARY

To address the above described challenges, a method is provided that includes obtaining individual behavior data from interactions of a target user with an application program on at least one computing devices, and obtaining crowd behavior data from interactions of a plurality of users with other instances of the application program on other computing devices. The method further includes executing a machine learning algorithm to determine one or more performance benchmarks for one or more tasks or chains of tasks based on the crowd behavior data, and aggregating the plurality of users into a plurality of user clusters based on similarity of one or more features between users. The method further includes classifying the target user into one of the plurality of user clusters based on similarity of one or more features between the target user and users in the user clusters, and from the individual behavior data and the crowd behavior data, identifying one or more focus features of the target user that underperform one or more benchmarks of the one or more features of the plurality of users in the user cluster to which the target user is classified. The method further includes, identifying targeted content associated with the one or more tasks or chains of tasks based on the one or more identified features of the target user, and delivering the targeted content via the computing device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The present disclosure is illustrated by way of example and not by way of limitation in the figures of the accompanying drawings, in which the like reference numerals indicate like elements and in which:

FIG. 1 shows a computer-implemented method according to an embodiment of the present description.

FIG. 2 shows a computer system according to an embodiment of the present description.

FIG. 3 shows an example of user clusters according to an embodiment of the present description.

FIG. 4 illustrates an exemplary computer game in which the computer-implemented method is applied according to an embodiment of the present description.

FIG. 5 shows another example of user clusters according to an embodiment of the present description.

FIG. 6 shows examples of features that may be used to classify users into user clusters in the web browser according to another embodiment of the present description.

FIG. 7 illustrates an exemplary web browser in which the computer-implemented method is applied according to another embodiment of the present description.

FIG. 8 shows an example computing system according to an embodiment of the present description.

### DETAILED DESCRIPTION

A selected embodiment of the present invention will now be described with reference to the accompanying drawings. It will be apparent to those skilled in the art from this disclosure that the following description of an embodiment of the invention is provided for illustration only and not for the purpose of limiting the invention as defined by the appended claims and their equivalents.

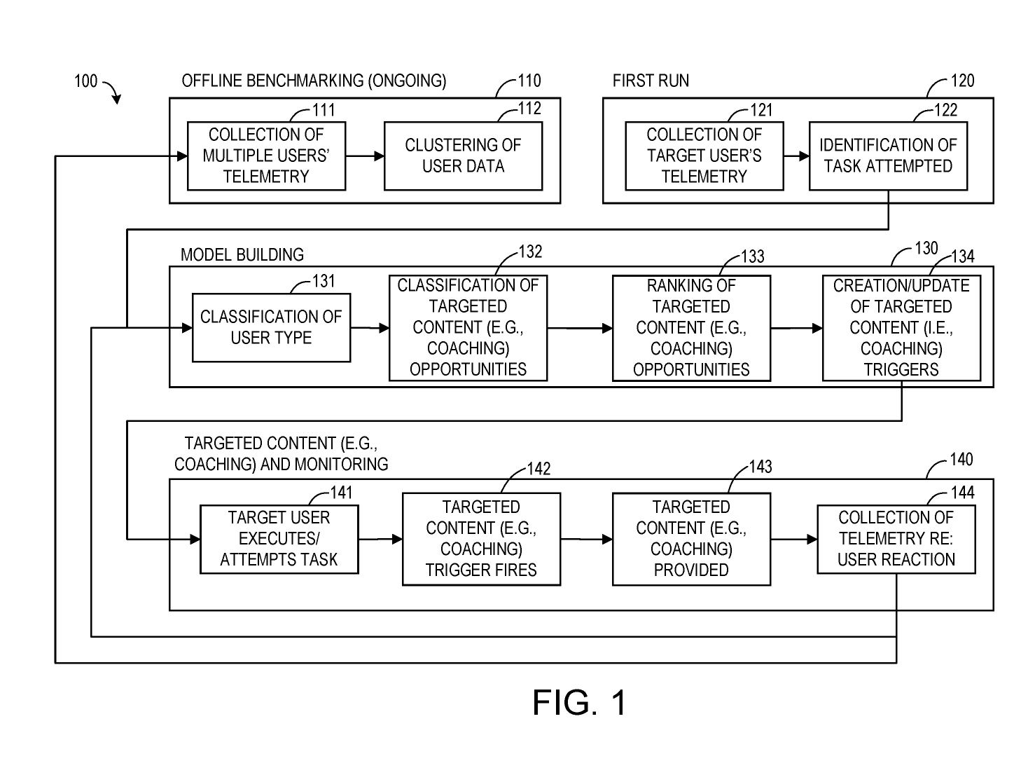

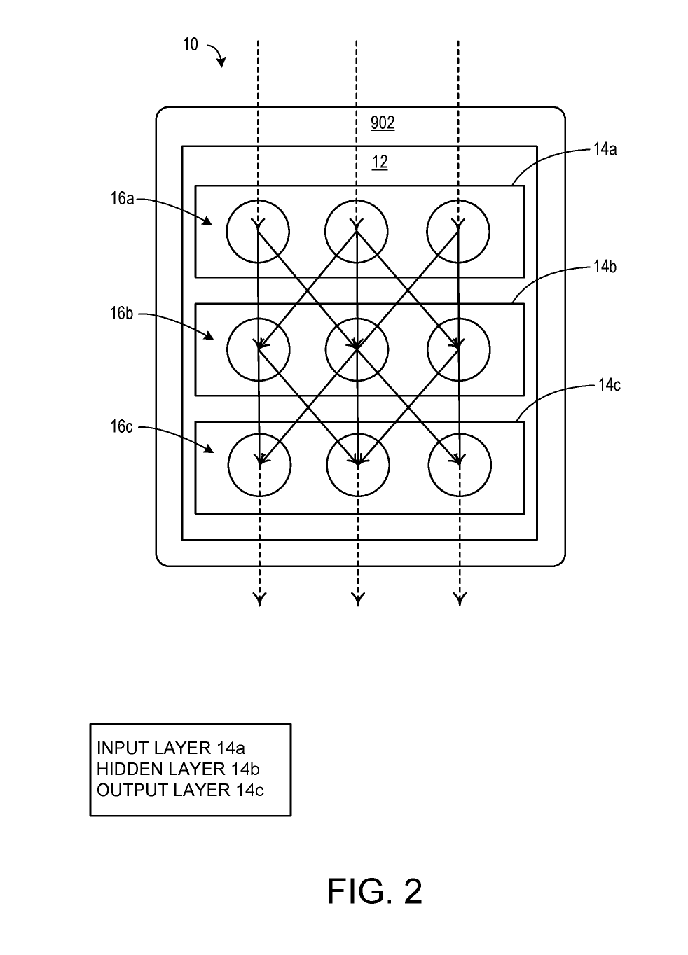

The present disclosure is directed to a computer-implemented method, an embodiment of which is shown in FIG. 1, and a computing system implementing the computer-implemented method of the present description, an embodiment of which is shown in FIG. 2.

Referring initially to FIG. 1, the computer-implemented method 100 comprises four general steps: ongoing offline benchmarking 110, a first run 120, model building 130, and targeted content and monitoring 140. It will be appreciated that the model building step 130 and the targeted content and monitoring step 140 are iteratively repeated while offline benchmarking 110 is continuously performed. Further, the term “coaching” is used herein to designate one type of targeted content that may be delivered. The offline benchmarking step 110 comprises obtaining crowd behavior data from a plurality of users, including the target user (step 111). This may be achieved by collecting telemetry data, or logging data from a plurality of users while an application program is running and the users are executing various tasks, thereby collecting background information about the crowd behavior of a plurality of users under circumstances that are similar to those of the target user. Thus, an application program may be configured to log various actions taken by a user, along with the state of the program at the time of the actions, and this data may be referred to as telemetry data. As one specific example, user input parameters received from an input device such as a keyboard, mouse, touchscreen, game controller, etc., may be logged as events in the application program transpire, and stored as user telemetry data for other users. The crowd behavior data may be compiled into a unified, overall benchmarking database to gauge the performance of individual target users with performance benchmarks. In this manner, the crowd behavior of the plurality of users is used as an “oracle” (i.e., predictor) of the target user's improvement potential, or a reference point against which the target user's behavior may be compared, so that specific areas for improvement can be identified. These specific areas for improvement may be specific tasks or chains of tasks executed by some of the plurality of users, which improve the target user's performance if imitated successfully.

The first run 120 comprises obtaining individual behavior data from a target user (step 121). When a new target user starts using the application program, telemetry data about the target user's behavior (including user inputs, etc.) is collected similarly to the crowd behavior data for subsequent comparison against the crowd behavior data.

The method 100 also comprises executing a machine learning algorithm (machine learning algorithm means) for determining one or more performance benchmarks for one or more tasks or chains of tasks based on the crowd behavior data, which may be accomplished by training a neural network having a plurality of layers on the individual and crowd behavior data gathered at steps 111 and 121, as described in more detail below. Turning to FIG. 2, the neural network 12, having a plurality of layers 14 on the individual and crowd behavior data, is implemented by one or more logic processors 902. As demonstrated by the arrows in FIG. 2, the flow of data is unidirectional with no feedback to the input. Each layer 14 comprises one or more nodes 16, otherwise known as perceptrons or “artificial neurons.” The layers 14 may comprise an input layer 14a with input layer nodes 16a, an intermediate hidden layer 14b with hidden layer nodes 16b, and an output layer 14c with output layer nodes 16c. Each node 16 accepts multiple inputs and generates a single output signal which branches into multiple copies that are in turn distributed to the other nodes as input signals. The output layer nodes 16c are feature detectors 16c configured to detect one or more features, each of which may be associated with statistical weights for each parameter input to the respective feature detector 16c. Each feature may be associated with one or more tasks and one or more performance benchmarks. A feature may be associated with tasks or chains of tasks (key strokes, mouse clicks, and web searches, for example) and performance benchmarks (elapsed time and number of user operations required to complete a given task, for example). Each feature detector 16c may function as a processing node, and one or more nodes may be implemented by a processor 902. Further, a memory, operatively coupled to the processor 902, may be provided for storing learned weights for each feature detector 16c. During training, the neural network learns optimal statistical weights for each feature detector 16c, so that the corresponding sets of weights for the features detected by the one or more feature detectors are adjusted with each iterative repetition of the method 100. In this embodiment, three layers 14a, 14b, and 14c are depicted, and three nodes are provided for each layer, but it will be appreciated that the invention is not limited to these, and any number of layers may be provided for the neural network 12, and any number of nodes may be provided for each layer. It will be appreciated that the system may be implemented as a platform functionality on an API, for example.

Turning back to FIG. 1, the offline benchmarking step 110 further comprises evaluating the crowd behavior data based on the corresponding set of weights, and aggregating the plurality of users into a plurality of user clusters based on similarity of one or more features between users (step 112). The crowd behavior data is subsequently used to categorize users according to a suitable machine learning technique such as k-means clustering, which uses unlabeled data to create a finite number of groups of users based on the similarity of their behaviors. These user clusters may correspond to differences in skill level, style of play, accuracy, speed, and reaction times, for example.

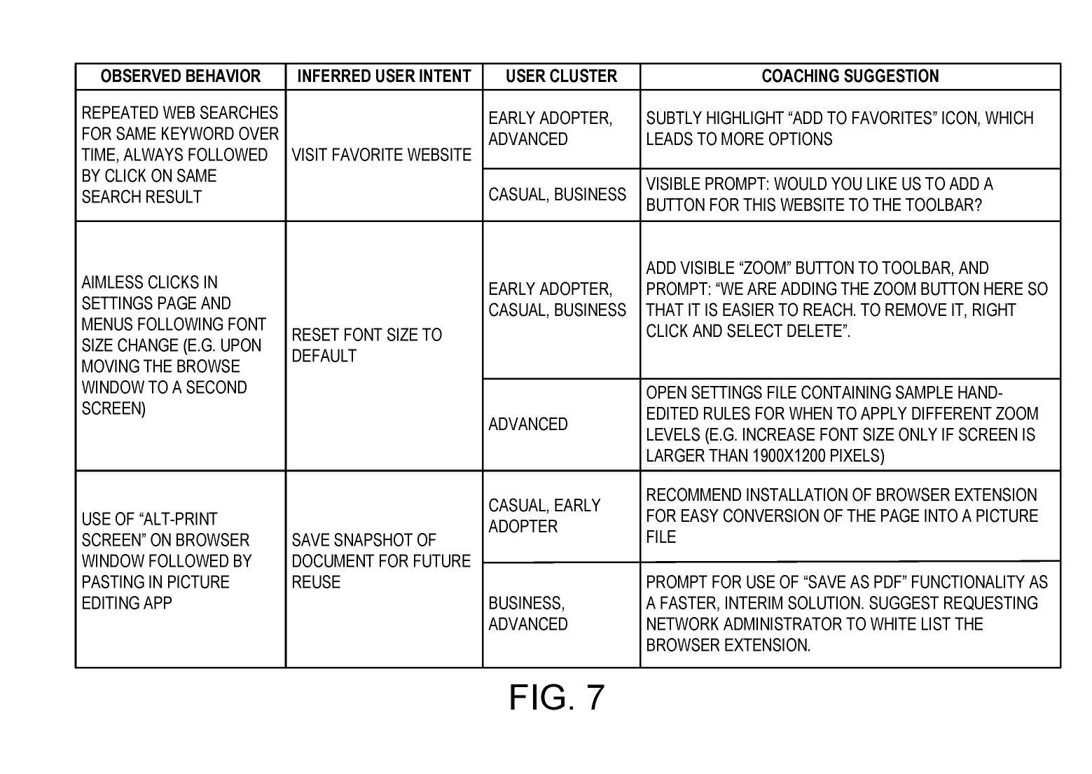

The first run 120 further comprises evaluating individual behavior data of the target user based on the corresponding set of weights of each feature detector, which detects features in the individual user behavior that then are associated with one or more tasks or chains of tasks and one or more benchmarks (step 122). The specific features and tasks to be evaluated in the individual behavior data (step 122) of the user may be determined in different ways. In some scenarios, the determination may be an inherent part of how a particular application program is designed. For example, in a car racing game, the main task would be to cross the finish line as quickly as possible. In other cases, the evaluated tasks may be specified by the user through a search query, for example, so that the one or more features detected by the one or more feature detectors are predetermined by the target user. In yet other embodiments, the task or chain of tasks may be inferred automatically by observing the user's behavior, especially repeated behavior patterns that are associated with a discernable user intent, so that the one or more features detected by the one or more feature detectors are predetermined by the neural network (see example of web browser in FIG. 7).

The model building step 130 comprises classifying the target user into one of a plurality of user clusters based on similarity of one or more features between the target user and users in the user clusters (step 131). Once sufficient crowd behavior data and user behavior data are collected via telemetry (e.g., collection of user inputs and application program states during specified application program events), one or a plurality of the user clusters (as previously categorized in step 112) are selected for the target user via a suitable classification technique, such as the k-Nearest Neighbor algorithm or one of its variants. For example, a target user in a computer game may be classified into an advanced user cluster for speed while simultaneously being classified into a beginner user cluster for scoring.

The model building step 130 further comprises identifying one or more focus features of the target user from the individual behavior data and the crowd behavior data (step 132). Opportunities for improvement are identified by breaking down the task execution data in self-contained pieces and evaluating 1) the extent of the performance discrepancy from ideal behavior (as determined by crowd behavior data) and consistency of the discrepancy (as summarized by the mean and standard deviation, for example), as well as 2) the impact of the discrepancy on the overall task performance. The one or more focus features of the target user may underperform the one or more benchmarks of the one or more features of the plurality of users in the user cluster to which the target user is classified significantly, that is, they may deviate from the benchmark by a predetermined deviation threshold percentage or value. Based on the one or more identified focus features of the target user, the targeted content and monitoring step 140 is performed, and targeted content is eventually delivered via the computing device for the one or more tasks or chains of tasks associated with the one or more identified focus features of the target user (step 143). As used herein, targeted content refers to content that is tailored to enable a user to more easily accomplish a task or chain of tasks within the application program, and thus, delivery of targeted content involves delivery of such targeted content. As discussed above, coaching is one type of targeted content.

To identify targeted content associated with the one or more tasks or chains of tasks based on the one or more identified features of the target user, the model building step 130 may further include ranking the one or more tasks or chains of tasks associated with the one or more identified focus features based on an evaluated potential of the target user for improvement on the one or more tasks or chains of tasks (step 133). Targeted content opportunities (discrepancies from the optimal/desired performance of peers in the target user's user cluster) may be ranked based on their potential impact on the user's performance on each task, as well as the user's specific cluster or category, appropriately delivering advanced coaching tips to advanced players and beginner coaching tips to beginner players, for example. For novice players, mastering the basic button operations of a racing game, including knowledge of the position of the brake button, would be ranked above coaching opportunities to improve braking performance or fine tune race car specifications (tire pressure, suspension configuration, etc.) in the racing game, for example. Coaching opportunities for efficiently completing the last turn of the race would also be prioritized before any coaching opportunities to efficiently complete other parts of the race, if the completion of the last turn of the race is the most critical part of the strategy for winning the race.

Once a set of targeted content (e.g., coaching) opportunities tailored to the target user has been identified, the method may create or update a set of customized triggers (step 134), so that the one or more tasks associated with the one or more identified focus features of the target user are arranged in a linked sequence and associated with customized triggers that may be temporal ranges and/or geographical ranges that define when and/or where targeted content is delivered. In other words, customized triggers are associated with targeted content cues that are observable and actionable by the target user, and provided to deliver targeted content at the right place and/or time. Although targeted content suggestions could be provided offline (e.g. by sending an email), they are generally far more effective if provided at the right time when the target user is attempting the task again (step 141) and the target user is able to immediately put the targeted content suggestion in practice. Thus, after the target user executes or attempts the one or more tasks (step 141) within the temporal and/or geographical ranges that trigger the customized triggers created or updated in step 134, the customized triggers are set off (step 142), and the targeted content (e.g. coaching) is delivered (step 143) via the computing device, for example by display on a display of the computing device. Such customized triggers may include specific times and locations in a virtual world of the game or application, and may be responsive or non-responsive to a target user's actions or other users' actions.

The content of the targeted content will be understood to encompass any kind of non-trivial instruction, teaching, hints, tips, advice, recommendation, guidance, aid, direction, warning, coaching and/or counsel that is directed to the target user using a computer application in order to accomplish a given goal. The delivery of targeted content may be implementation dependent. Some embodiments may use textual, visual, auditory, and tactile stimuli to deliver the targeted content depending on the nature of the application. In other embodiments, the targeted content suggestion may be generated in natural language by combining constructs from a vocabulary of concepts that are relevant to the domain (i.e. the browser's interface, titles of web pages, prior search queries). Visual aids that deliver the targeted content may also be non-textual, such as a simple highlight, underline, box, or flashes that attract a target user's attention, for example. The timing of the delivery may also be implementation dependent. For example, there may be an element of time-sensitivity in a video game where split-seconds matter, and the targeted content may be delivered immediately when the targeted content is triggered (step 142). However, the targeted content may alternatively be delivered with a predetermined time delay after the targeted content is triggered (step 142). The targeted content may be delivered by an API hint engine provided with a hint library that is instantiated on one or more computers.

Following the delivery of targeted content (step 143), the user's reaction to the targeted content is recorded by the telemetry system and fed to a centralized database (step 144). The method is then iteratively repeated by proceeding to step 131. Depending on how successfully the user implements the targeted content suggestion, the system will keep the target user in the same user cluster, or reclassify the target user into another user cluster and stop providing the targeted content suggestion (because the user has “graduated” to a different user cluster, for example) or attempt a different targeted content suggestion that the target user may be in a better position to execute. At the same time, the post-targeted content individual behavior data of the target user is fed back into the overall benchmarking database (step 111) to gauge the overall effectiveness of certain suggestions for a given user cluster and therefore the suitability of their use in the given user cluster in the future.

Due to the iterative nature of the computer-implemented method 100, the definitions of the user clusters, obtained crowd behavior data, and the sets of statistical weights of the feature detectors may dynamically change with each successive iteration of the method 100, resulting in a feedback loop. When the method 100 is iteratively repeated following the delivery of targeted content, the individual behavior data of the target user is re-evaluated, the target user is reclassified, one or more focus features are re-identified, and targeted content is re-delivered based on change in performance of one or more focus features against the one or more benchmarks. For example, when obtained crowd behavior data is initially sparse, the system may initially aggregate the plurality of users into only two user clusters: a beginner user cluster and an advanced user cluster. However, as more crowd behavior data is obtained, and different groups of similarities among the users' features are detected, the plurality of users may be subsequently aggregated into more clusters and/or differently defined clusters: a beginner user cluster, an intermediate user cluster, and an advanced user cluster, for example. As different sequences of features are correlated into different chains of tasks with different performance benchmarks, the focus features of the target users and the identification thereof are likely to change with successive iterations of the method 100. For each user cluster, effective targeted content suggestions are favored to be retained in successive iterations, while ineffective targeted content suggestions are likely to be subsequently abandoned, responsive to aggregated statistics on the effectiveness of each targeted content suggestion for each user cluster. Consequently, the delivered targeted content is likely to evolve accordingly with changes in the identified focus features and user clusters.

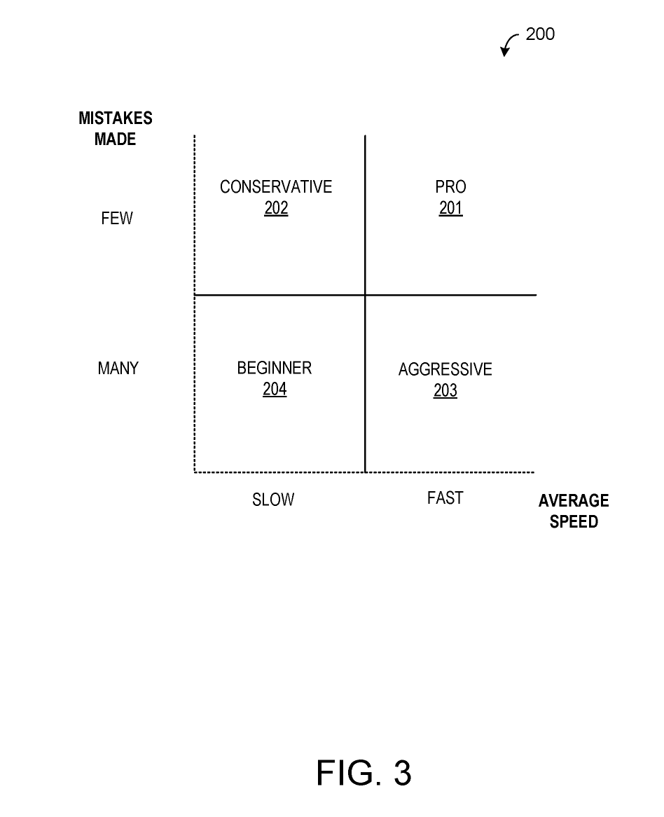

Referring to FIG. 3, an example is illustrated of user clusters according to an embodiment of the present description. In a car racing game, there may be “pros” 201 (who consistently run fast laps and rarely make mistakes), “conservative drivers” 202 (who clock slower laps but generally do not make mistakes), “aggressive drivers” 203 (who are generally fast but prone to making mistakes), and “beginners” 204 (who are neither fast nor consistent). Although “Conservative” and “Aggressive” drivers may average the same lap times, the kind of targeted content that they need to graduate to “pro” level will be intuitively different. A practical embodiment of this technique may and generally will use far more than two simple features to describe a user. That will lead to an exponentially more complex potential distribution of behaviors, and of opportunities to improve overall performance.

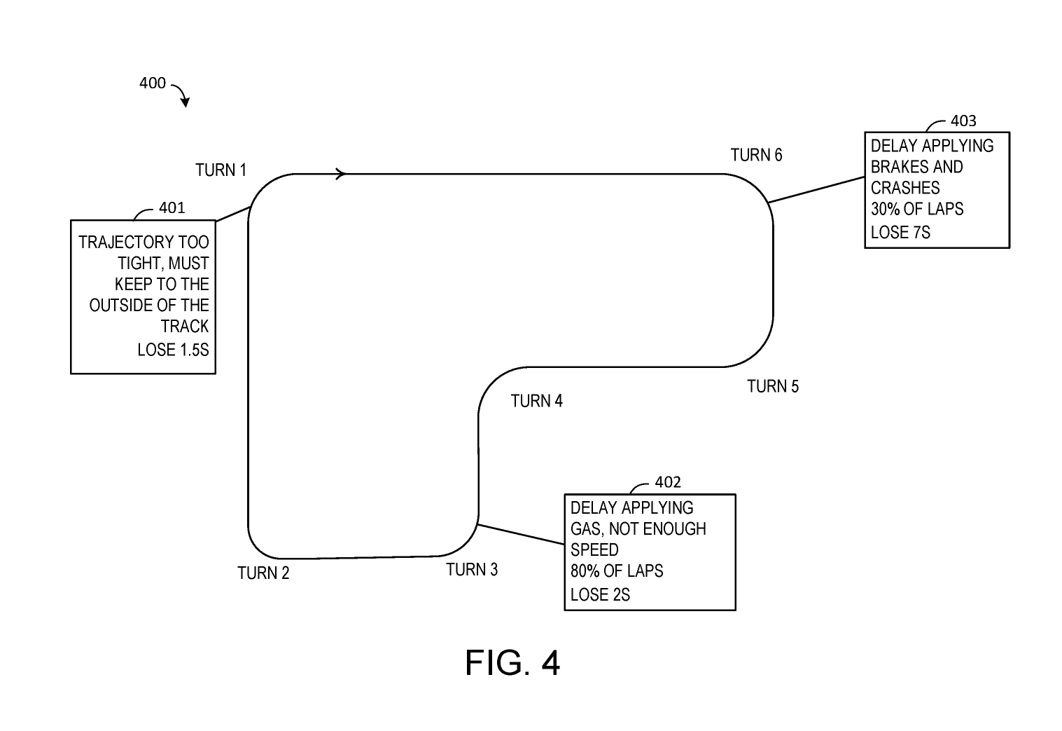

Turning to FIG. 4, an exemplary computer game is illustrated in which the example computer-implemented method is applied according to an embodiment of the present invention. Specifically, the delivery of targeted content suggestions in a car racing simulation is depicted in FIG. 4, in which geographical ranges correspond to positions on a constrained path along which the task or chain of tasks are organized, namely, a racetrack, and temporal ranges are associated with timings of the one or more tasks or chains of tasks along the constrained path, or racetrack. The crowd behavior data is evaluated based on the corresponding sets of weights, and the plurality of users are aggregated into a plurality of user clusters based on similarity of one or more features between users (step 112). In this example, the features may include such metrics as the time between entry and exit, the length of brake application, the length of gas application, the number of directional changes, and the average distance from the optimal trajectory, for example, all of which are determined ultimately based on user input from user input devices associated with the computing device. The individual behavior data of the target user is then evaluated based on the corresponding set of weights for each feature detector (step 122).

Once the target user is classified into the appropriate user cluster based on the evaluation (step 131), one or more focus features of the target user are identified. Since users may have different skill or performance levels for different features, users may belong to different user clusters depending on the focus feature. For the target user on track 400, identified focus features at three segments stand out compared to the target user's nearest neighbors (corresponding to crowd behavior) as well as users who are 10% faster on average, for example. At turn 1, the identified focus feature is a turn speed that is 1.5 seconds slower than the target user's cohort in the user cluster. Likewise, at turn 6, the identified focus is a turn speed that is 7 seconds slower than the target user's cohort; at turn 3, the identified focus is a turn speed that is 2 seconds slower than the target user's cohort. Customized triggers are then provided to deliver targeted content at the appropriate locations: turn 1, turn 6, and turn 3 (step 134). Thus, the one or more identified focus features of the target user are associated with customized triggers that are geographical ranges. However, it will be appreciated that customized triggers may alternatively be temporal ranges, or be both geographical ranges and temporal ranges.

Based on the one or more identified focus features of the target user, targeted content is delivered for the one or more tasks associated with the one or more identified focus features of the target user (step 143), once the customized triggers are set off at the appropriate locations. For example, the targeted content suggestion 401 for turn 1 is to keep to the outside of the track (as opposed to the inside) before turning in; the targeted content suggestion 403 for turn 6 is to delay applying the brakes; and the targeted content suggestion 402 for turn 3 is to delay applying the gas. The customized triggers for the targeted content suggestions may also be adjusted based on the user cluster to which the target user is classified. For example, for advanced users with fast reflexes, the user may be instructed to cue a braking operation at the bridge on the race track, while novice users may be instructed to cue a braking operation at the house on the race track. It will be appreciated that the customized triggers may be associated with targeted content cues that are observable and actionable by the target user, especially within the virtual world of the game or application.

Following the delivery of targeted content (step 143), post-targeted content individual behavior data of the target user is subsequently evaluated based on the corresponding set of weights of each feature detector (step 144). If a user who was classified into the advanced user cluster fails to successfully perform at a certain turn, the system may reclassify the target user into an intermediate or novice user cluster, in which targeted content suggestion are tailored to slower reflex responses. Otherwise, successful performance at a certain turn may advance the target user to a higher level user cluster.

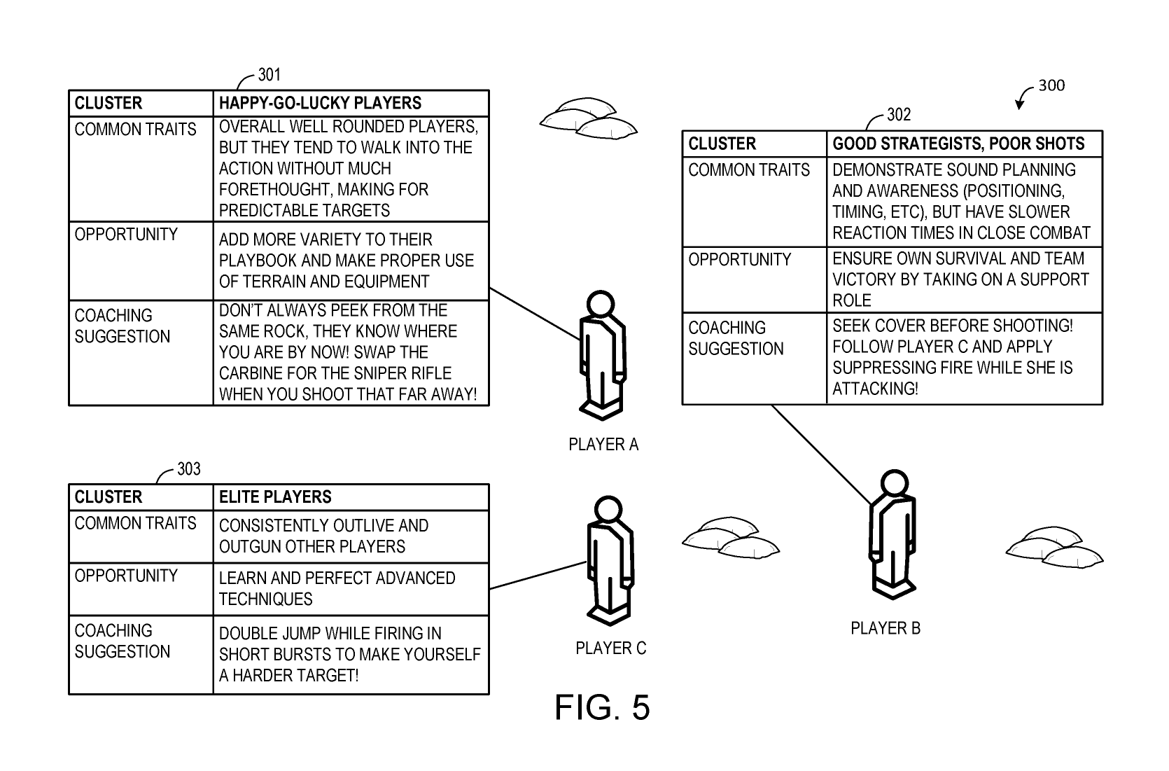

Referring to FIG. 5, another example is illustrated of user clusters according to an embodiment of the present description. In a first person shooter game 300, there may be a “happy go lucky” cluster 301, which includes overall well rounded players who tend to walk into action without much forethought, making them easy and predictable targets in multiplayer games. There may also be a “good strategists, poor shots” cluster 302, which include players who demonstrate sound planning and awareness (positioning, timing, etc.), but have slower reaction times in close combat. In addition, there may also be an “elite players” cluster 303, which include players who consistently outlive and outgun other players. Targeted content suggestions are tailored to the common traits and targeted content opportunities that are particular to each user cluster.

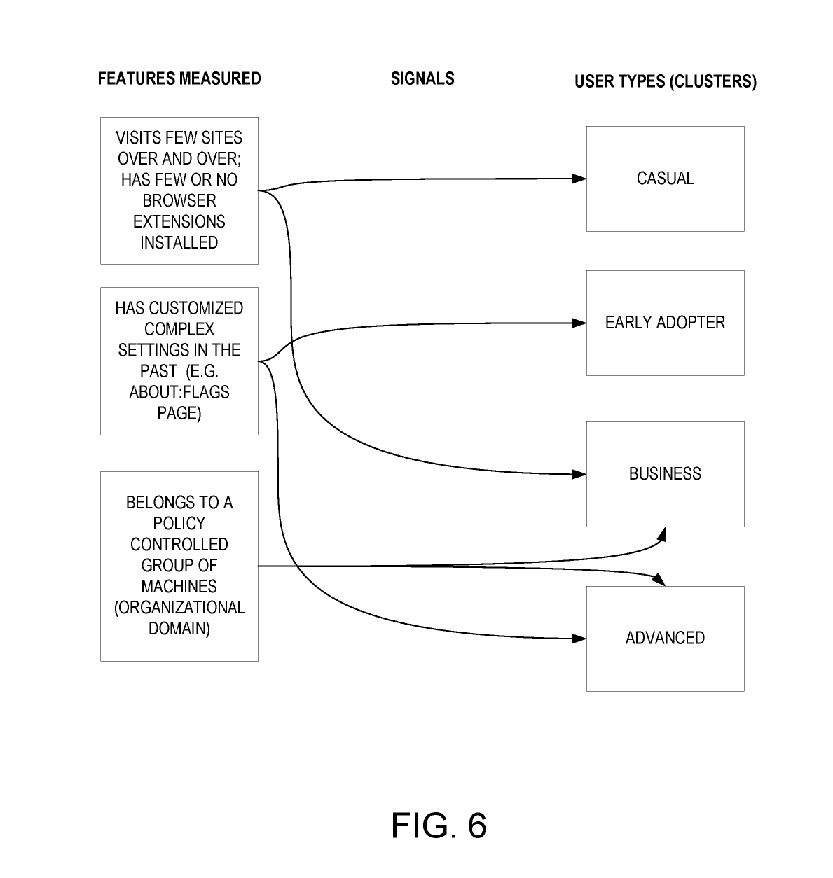

Referring to FIG. 6, another example is illustrated of user clusters according to an embodiment of the present description that is applied to web browsers. In certain embodiments, the target user may be classified into one of a plurality of user clusters based on similarity of one or more features, such as whether the target user has launched the browser's developer tools, whether the target has installed debuggers or SDKs on the computer, or other indirect signals. The ability to perform the above tasks would highly suggest that the target user is an advanced user, and the target user would be appropriately classified into the advanced user cluster, which includes users who are able to customize certain facets of the browser operation by writing some simple scripting code. Other features that suggest the advanced abilities of the target user may include belonging to a policy controlled group of machines. In contrast, the ability to customize other complex settings may not necessarily suggest that the target user is an advanced user, but may instead indicate that the target user is an early adopter, for example. On the other hand, a target user who visits a few sites repeatedly, and has few or no browser extensions installed may be appropriately classified into the casual or business user cluster.

Referring to FIG. 7, three scenarios of an exemplary web browser are illustrated in which the computer-implemented method is applied according to an embodiment of the present invention. Specifically, the inference step in the evaluation of the individual behavior data of the target user is illustrated, in which repeated behavior patterns are associated with a discernable user intent (step 122). For automatically inferred tasks, the inference step may be a machine learning classification process that uses telemetry as an input, any common classification technique as an algorithm (e.g. Support Vector Machines, Neural Networks, Decision Tree Learning, and Supervised Machine Learning), and a known list of tasks as an output. In most embodiments this known tasks list will be manually curated depending on the purpose of the computer application for which targeted content is needed (i.e. what exactly the application's creators want users to achieve). In other embodiments, especially in high unstructured domains, fully automated task creation and identification logic would have practical application.

In the example of a web browser, repeated behavior patterns of the target user may be web searches, mouse clicks, and key strokes. The neural network is trained, having a plurality of layers on the individual and crowd behavior data, each of the layers including feature detectors (the features comprising web searches, mouse clicks, and key strokes, for example). The web searches, mouse clicks, and key strokes may have corresponding sets of statistical weights. Evaluating individual and crowd behavior data based on these sets of statistical weights, the system associates sequences of features that are highly correlated, and correlates these sequences of features into chains of tasks.

In the first scenario, the user behavior data may indicate that the user conducts repeated web searches for the same keyword over time, followed by a click on the same search result. This repetitive behavior pattern is inferred as a chain of tasks with a discernable user intent (visiting a favorite website). By inference, this chain of tasks may be identified as focus features of the target user that significantly underperform the one or more benchmarks of the features of a plurality of users in the user cluster to which the target user is classified. In this case, the benchmarks used are the elapsed time and the aggregate number of key strokes and clicks that are required to execute the task. The majority of the users in the target user's cohort may simply use the “add to favorites” function in the web browser, thereby requiring less time and mouse clicks to execute the task. If the target user belongs to the early adopter or advanced user cluster, the targeted content that is delivered may instruct the target user to click on the “add to favorites” icon, by displaying natural language text or simply by highlighting the relevant icon, for example. On the other hand, if the target user belongs to the casual or business user cluster, the targeted content that is delivered may instruct the target user on how to add a button for the favorite website to the toolbar. Thus, it will be appreciated that the same targeted content may be delivered to more than one user cluster.

In the second scenario, the user behavior data may indicate that the user continues to open and close the settings without changing anything (indicating failure to complete a task), and shortly thereafter either open a different browser or execute a roundabout series of steps to reach the intended objective (resetting the font size to default, for example). This repetitive behavior pattern is inferred as a chain of tasks with a discernable user intent (resetting the font size to default). By inference, this chain of tasks may be identified as focus features of the target user that significantly underperform the one or more benchmarks of the features of a plurality of users in the user cluster to which the target user is classified. In this case, the benchmarks used are the elapsed time and the aggregate number of key strokes and clicks that are required to execute a task. The majority of the users in the target user's cohort may simply find the intended setting and immediately configure a shortcut (or whatever the case may be) to the same page, thereby requiring less time and mouse clicks to execute the task. If the target user belongs to an early adopter, casual, or business user cluster, the targeted content that is delivered may instruct the target user to add a visible “zoom” button to the tool bar, and notify the user that the button can be removed by right clicking and selecting delete. On the other hand, if the target user belongs to an advanced user cluster, the targeted content that is delivered may instruct the user to open a settings file containing sample hand-edited rules for when to apply different zoom levels (increasing font size only if the screen is larger than 1900×1200 pixels, for example).

It will be appreciated that, in the second scenario, the targeted content that is delivered for the early adopter user cluster may evolve with successive iterations of the computer-implemented method. For example, if most early adopter users end up actually deleting the “zoom button” on the toolbar, a new suggestion specific to these early adopter users may eventually be created by the system. For example, the targeted content system may instead deliver the suggestion that “you can click Control-0 to reset the font size.”

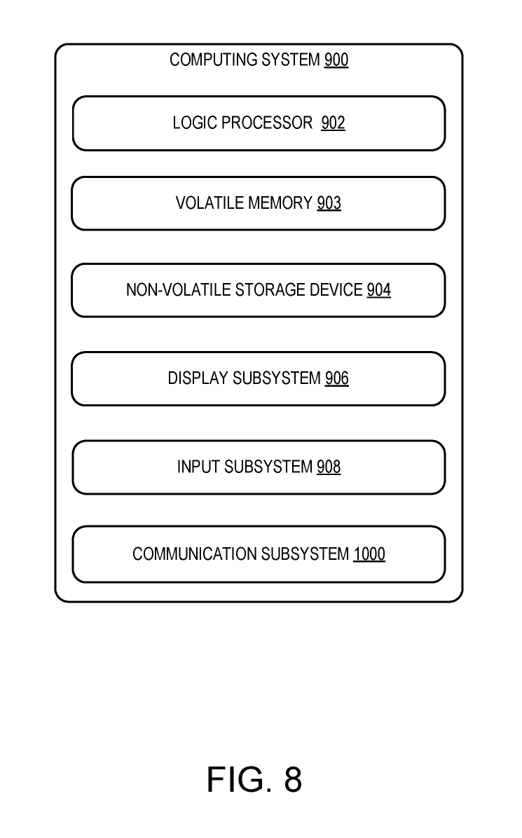

In the third scenario, the user behavior data may indicate that the target user is using the “Alt-print screen” key combination on the browser window, followed by pasting the screenshot into a picture editing application. This repetitive behavior pattern is inferred as a task with a discernable user intent (saving a snapshot of the browser screen for future reference). By inference, this chain of tasks may be identified as focus features of the target user that significantly underperform the one or more benchmarks of the features of a plurality of users in the user cluster to which the target user is classified. In this case, the benchmarks used are the elapsed time, the number of applications opened, and aggregate number of key strokes and clicks that are required to execute the task. The majority of the users in the target user's cohort may simply use the “save as PDF” function or a browser extension. If the target user belongs to a casual or early adopter user cluster, the targeted content that is delivered may instruct the target user to install a browser extension for easy conversion of the webpage into a picture file. On the other hand, if the target user belongs to a business or advanced user cluster, the targeted content that is delivered may instruct the target user to use the “save as PDF” function, and suggest requesting the network administrator to approve the installation of the browser extension. FIG. 8 schematically shows a non-limiting embodiment of a computing system 900 that can enact one or more of the methods and processes described above. Computing system 900 is shown in simplified form. Computing system 900 may embody one or more of the neural network 12 of FIG. 2. Computing system 900 may take the form of one or more personal computers, server computers, tablet computers, home-entertainment computers, network computing devices, gaming devices, mobile computing devices, mobile communication devices (e.g., smart phone), and/or other computing devices, wearable computing devices such as smart wristwatches and head mounted augmented reality devices, computerized medical devices.

Computing system 900 includes a logic processor 902 volatile memory 903, and a non-volatile storage device 904. Computing system 900 may optionally include a display subsystem 906, input subsystem 908, communication subsystem 1000, and/or other components not shown in FIG. 10.

Logic processor 902 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors (hardware) configured to execute software instructions. Additionally or alternatively, the logic processor may include one or more hardware logic circuits or firmware devices configured to execute hardware-implemented logic or firmware instructions. Processors of the logic processor 902 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 904 includes one or more physical devices configured to hold instructions executable by the logic processors to implement the methods and processes described herein. When such methods and processes are implemented, the state of non-volatile storage device 904 may be transformed—e.g., to hold different data.

Non-volatile storage device 904 may include physical devices that are removable and/or built-in. Non-volatile storage device 904 may include optical memory (e.g., CD, DVD, HD-DVD, Blu-Ray Disc, etc.), semiconductor memory (e.g., ROM, EPROM, EEPROM, FLASH memory, etc.), and/or magnetic memory (e.g., hard-disk drive, floppy-disk drive, tape drive, MRAM, etc.), or other mass storage device technology. Non-volatile storage device 904 may include nonvolatile, dynamic, static, read/write, read-only, sequential-access, location-addressable, file-addressable, and/or content-addressable devices. It will be appreciated that non-volatile storage device 904 is configured to hold instructions even when power is cut to the non-volatile storage device 904.

Volatile memory 903 may include physical devices that include random access memory. Volatile memory 903 is typically utilized by logic processor 902 to temporarily store information during processing of software instructions. It will be appreciated that volatile memory 903 typically does not continue to store instructions when power is cut to the volatile memory 903.

Aspects of logic processor 902, volatile memory 903, and non-volatile storage device 904 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 900 typically implemented in software by a processor to perform a particular function using portions of volatile memory, which function involves transformative processing that specially configures the processor to perform the function. Thus, a module, program, or engine may be instantiated via logic processor 902 executing instructions held by non-volatile storage device 904, using portions of volatile memory 903. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 906 may be used to present a visual representation of data held by non-volatile storage device 904. The visual representation may take the form of a graphical user interface (GUI). As the herein described methods and processes change the data held by the non-volatile storage device, and thus transform the state of the non-volatile storage device, the state of display subsystem 906 may likewise be transformed to visually represent changes in the underlying data. Display subsystem 906 may include one or more display devices utilizing virtually any type of technology. Such display devices may be combined with logic processor 902, volatile memory 903, and/or non-volatile storage device 904 in a shared enclosure, or such display devices may be peripheral display devices.

When included, input subsystem 908 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor.

When included, communication subsystem 1000 may be configured to communicatively couple various computing devices described herein with each other, and with other devices. Communication subsystem 1000 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 900 to send and/or receive messages to and/or from other devices via a network such as the Internet.

In one particular embodiment a computing device may be provided that includes a processor and non-volatile memory, the non-volatile memory storing instructions which, upon execution by the processor, cause the processor to: obtain individual behavior data from interactions of a target user with an application program on at least one computing device, obtain crowd behavior data from interactions of a plurality of users with other instances of the application program on other computing devices, execute a machine learning algorithm means for determining one or more performance benchmarks for one or more tasks or chains of tasks based on the crowd behavior data, aggregate the plurality of users into a plurality of user clusters based on similarity of one or more features between users, classify the target user into one of the plurality of user clusters based on similarity of one or more features between the target user and users in the user clusters, from the individual behavior data and the crowd behavior data, identify one or more focus features of the target user that underperform the one or more performance benchmarks of the one or more features of the plurality of users in the user cluster to which the target user is classified, identify targeted content associated with the one or more tasks or chains of tasks based on the one or more identified features of the target user, and deliver the targeted content via the computing device.

As described above, targeted content suggestions in computer games and web browser applications are tailored to the features and metrics of the individual player for successful execution. In other words, successful targeted content suggestions result in statistically significant improvements in gaming outcome and web browser operation. The targeted content system continuously updates its internal model of the user clusters, and of the efficacy of the suggestions provided, testing new suggestions in real time with different users in a given user cluster, in order to see which approach is more congenial to that particular user cluster. It will be appreciated that, although gaming-related and web browser-related examples are used for explanatory purposes in this narrative, the present embodiments are not constrained to gaming applications and web browser applications. Instead, they can potentially be applied to any task requiring a target user to go through a non-trivial series of steps while using a computer application in order to accomplish a given goal, encompassing language learning modules, driver education, and massive open online courses.

The present disclosure further includes the following aspects. According to one aspect of the present disclosure, a method performed by one or more computing devices is disclosed, the method including obtaining individual behavior data from interactions of a target user with an application program on at least one computing device, obtaining crowd behavior data from interactions of a plurality of users with other instances of the application program on other computing devices, determining one or more performance benchmarks for one or more tasks or chains of tasks based on the crowd behavior data, aggregating the plurality of users into a plurality of user clusters based on similarity of one or more features between users, classifying the target user into one of the plurality of user clusters based on similarity of one or more features between the target user and users in the user clusters, from the individual behavior data and the crowd behavior data, identifying one or more focus features of the target user that underperform one or more of the performance benchmarks of the one or more features of the plurality of users in the user cluster to which the target user is classified, identifying targeted content associated with the one or more tasks or chains of tasks based on the one or more identified features of the target user, and delivering the targeted content via the computing device. In this aspect, determining the one or more performance benchmarks may be accomplished at least in part by executing a machine learning algorithm. In this aspect, executing the machine learning algorithm may include training a neural network having a plurality of layers on the individual and crowd behavior data, at least one of the layers including one or more feature detectors detecting one or more features, each of the feature detectors having a corresponding set of weights, each feature being associated with the one or more tasks or chains of tasks and the one or more performance benchmarks, and evaluating the individual and crowd behavior data based on the corresponding set of weights. In this aspect, the one or more features detected by the one or more feature detectors may be predetermined by the target user and/or the neural network. In this aspect, determining the one or more performance benchmarks may be accomplished at least in part by executing a machine learning algorithm. In this aspect, the machine learning algorithm may utilize a machine learning technique selected from the group consisting of a support vector machine, decision tree learning, and supervised machine learning. In this aspect, the method may be iteratively repeated following the delivery of targeted content, so that the individual behavior data of the target user is re-evaluated, the target user is reclassified, one or more focus features are re-identified, and targeted content is re-delivered based on change in performance of one or more focus features against the one or more performance benchmarks. In this aspect, the corresponding sets of weights for the features detected by the one or more feature detectors may be adjusted with each iterative repetition of the method. In this aspect, the one or more tasks associated with the one or more identified focus features of the target user may be arranged in a linked sequence and associated with customized triggers. In this aspect, the customized triggers may be associated with targeted content cues that are observable and actionable by the target user. In this aspect, the customized triggers may be adjusted based on the user cluster to which the target user is classified. In this aspect, the customized triggers may be temporal ranges and/or geographical ranges. In this aspect, the geographical ranges may correspond to positions on a constrained path along which the task or chain of tasks are organized, and the temporal ranges are associated with timings of the one or more tasks or chains of tasks along the constrained path. In this aspect, the targeted content may be delivered by a hint engine accessible via an application programming interface and provided with a hint library that is instantiated on the one or more computers. In this aspect, the targeted content may be delivered via textual, auditory, visual, and/or tactile medium. In this aspect, the delivery of targeted content may include ranking the one or more tasks or chains of tasks associated with the one or more identified focus features based on an evaluated potential of the target user for improvement on the one or more tasks or chains of tasks.

According to another aspect of the present disclosure, a computing device is disclosed, the computing device including a processor and non-volatile memory, the non-volatile memory storing instructions which, upon execution by the processor, cause the processor to: obtain individual behavior data from interactions of a target user with an application program on at least one computing device, obtain crowd behavior data from interactions of a plurality of users with other instances of the application program on other computing devices, determine one or more performance benchmarks for one or more tasks or chains of tasks based on the crowd behavior data, aggregate the plurality of users into a plurality of user clusters based on similarity of one or more features between users, classify the target user into one of the plurality of user clusters based on similarity of one or more features between the target user and users in the user clusters, from the individual behavior data and the crowd behavior data, identify one or more focus features of the target user that underperform the one or more performance benchmarks of the one or more features of the plurality of users in the user cluster to which the target user is classified, identify targeted content associated with the one or more tasks or chains of tasks based on the one or more identified features of the target user, and deliver the targeted content via the computing device. In this aspect, the processor may be configured to determine the one or more performance benchmarks at least in part by executing a machine learning algorithm, according to which the processor is further configured to: train a neural network having a plurality of layers on the individual and crowd behavior data, at least one of the layers including one or more feature detectors detecting one or more features, each of the feature detectors having a corresponding set of weights, each feature being associated with one or more tasks or chains of tasks and one or more performance benchmarks, and evaluate the individual and crowd behavior data based on the corresponding set of weights. In this aspect, one or more features detected by the one or more feature detectors may be predetermined by the target user and/or the neural network. In this aspect, the method may be iteratively repeated following the delivery of targeted content, so that the individual behavior data of the target user is re-evaluated, the target user is reclassified, one or more focus features are re-identified, and targeted content is re-delivered based on change in performance of one or more focus features against the one or more performance benchmarks. In this aspect, the corresponding sets of weights for the features detected by the one or more feature detectors may be adjusted with each iterative repetition of the method. In this aspect, the one or more tasks associated with the one or more identified focus features of the target user may be arranged in a linked sequence and associated with customized triggers. In this aspect, the customized triggers may be adjusted based on the user cluster to which the target user is classified. In this aspect, the customized triggers may be temporal ranges and/or geographical ranges. Any or all of the above-described examples may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method performed by one or more computing devices, the method comprising:
obtaining individual behavior data from interactions of a target user with an application program on at least one computing device;
obtaining crowd behavior data from interactions of a plurality of users with other instances of the application program on other computing devices;
determining one or more performance benchmarks for one or more tasks or chains of tasks based on the crowd behavior data;
aggregating the plurality of users into a plurality of user clusters based on similarity of one or more features between users;
classifying the target user into one of the plurality of user clusters based on similarity of one or more features between the target user and users in the user clusters;
from the individual behavior data and the crowd behavior data, identifying one or more focus features of the target user that underperform one or more of the performance benchmarks of the one or more features of the plurality of users in the user cluster to which the target user is classified;
identifying targeted content associated with the one or more tasks or chains of tasks based on the one or more identified features of the target user; and
delivering the targeted content via the computing device.

2. The method of claim 1,
wherein determining the one or more performance benchmarks is accomplished at least in part by executing a machine learning algorithm;
wherein executing the machine learning algorithm includes:
training a neural network having a plurality of layers on the individual and crowd behavior data, at least one of the layers including one or more feature detectors detecting one or more features, each of the feature detectors having a corresponding set of weights, each feature being associated with the one or more tasks or chains of tasks and the one or more performance benchmarks; and
evaluating the individual and crowd behavior data based on the corresponding set of weights; and
wherein the one or more features detected by the one or more feature detectors are predetermined by the target user and/or the neural network.

3. The method of claim 1,
wherein determining the one or more performance benchmarks is accomplished at least in part by executing a machine learning algorithm;
wherein the machine learning algorithm utilizes a machine learning technique selected from the group consisting of a support vector machine, decision tree learning, and supervised machine learning.

4. The method of claim 2, wherein the method is iteratively repeated following the delivery of targeted content, so that the individual behavior data of the target user is re-evaluated, the target user is reclassified, one or more focus features are re-identified, and targeted content is re-delivered based on change in performance of one or more focus features against the one or more performance benchmarks.

5. The method of claim 4, wherein the corresponding sets of weights for the features detected by the one or more feature detectors are adjusted with each iterative repetition of the method.

6. The method of claim 1, wherein the one or more tasks associated with the one or more identified focus features of the target user are arranged in a linked sequence and associated with customized triggers.

7. The method of claim 6, wherein the customized triggers are associated with targeted content cues that are observable and actionable by the target user.

8. The method of claim 6, wherein the customized triggers are adjusted based on the user cluster to which the target user is classified.

9. The method of claim 6, wherein the customized triggers are temporal ranges and/or geographical ranges.

10. The method of claim 9, wherein the geographical ranges correspond to positions on a constrained path along which the task or chain of tasks are organized, and the temporal ranges are associated with timings of the one or more tasks or chains of tasks along the constrained path.

11. The method of claim 1, wherein the targeted content is delivered by a hint engine accessible via an application programming interface and provided with a hint library that is instantiated on the one or more computers.

12. The method of claim 1, wherein the targeted content is delivered via textual, auditory, visual, and/or tactile medium.

13. The method of claim 1, wherein the delivery of targeted content includes ranking the one or more tasks or chains of tasks associated with the one or more identified focus features based on an evaluated potential of the target user for improvement on the one or more tasks or chains of tasks.

14. A computing device, comprising:
a processor and non-volatile memory, the non-volatile memory storing instructions which, upon execution by the processor, cause the processor to:
obtain individual behavior data from interactions of a target user with an application program on at least one computing device;
obtain crowd behavior data from interactions of a plurality of users with other instances of the application program on other computing devices;
determine one or more performance benchmarks for one or more tasks or chains of tasks based on the crowd behavior data;
aggregate the plurality of users into a plurality of user clusters based on similarity of one or more features between users;
classify the target user into one of the plurality of user clusters based on similarity of one or more features between the target user and users in the user clusters;
from the individual behavior data and the crowd behavior data, identify one or more focus features of the target user that underperform the one or more performance benchmarks of the one or more features of the plurality of users in the user cluster to which the target user is classified; and
identify targeted content associated with the one or more tasks or chains of tasks based on the one or more identified features of the target user; and
deliver the targeted content via the computing device.

15. The device of claim 14, wherein the processor is configured to determine the one or more performance benchmarks at least in part by executing a machine learning algorithm, according to which the processor is further configured to:
train a neural network having a plurality of layers on the individual and crowd behavior data, at least one of the layers including one or more feature detectors detecting one or more features, each of the feature detectors having a corresponding set of weights, each feature being associated with one or more tasks or chains of tasks and one or more performance benchmarks; and
evaluate the individual and crowd behavior data based on the corresponding set of weights; and
wherein one or more features detected by the one or more feature detectors are predetermined by the target user and/or the neural network.

16. The device of claim 15, wherein the method is iteratively repeated following the delivery of targeted content, so that the individual behavior data of the target user is re-evaluated, the target user is reclassified, one or more focus features are re-identified, and targeted content is re-delivered based on change in performance of one or more focus features against the one or more performance benchmarks.

17. The device of claim 16, wherein the corresponding sets of weights for the features detected by the one or more feature detectors are adjusted with each iterative repetition of the method.

18. The device of claim 14,
wherein the one or more tasks associated with the one or more identified focus features of the target user are arranged in a linked sequence and associated with customized triggers;
wherein the customized triggers are adjusted based on the user cluster to which the target user is classified.

19. The device of claim 18, wherein the customized triggers are temporal ranges and/or geographical ranges.

20. A computing device, comprising:
a processor and non-volatile memory, the non-volatile memory storing instructions which, upon execution by the processor, cause the processor to:
obtain individual behavior data from interactions of a target user with an application program on at least one computing device;
obtain crowd behavior data from interactions of a plurality of users with other instances of the application program on other computing devices;
execute a machine learning algorithm means for determining one or more performance benchmarks for one or more tasks or chains of tasks based on the crowd behavior data;
aggregate the plurality of users into a plurality of user clusters based on similarity of one or more features between users;
classify the target user into one of the plurality of user clusters based on similarity of one or more features between the target user and users in the user clusters;
from the individual behavior data and the crowd behavior data, identify one or more focus features of the target user that underperform the one or more performance benchmarks of the one or more features of the plurality of users in the user cluster to which the target user is classified;
identify targeted content associated with the one or more tasks or chains of tasks based on the one or more identified features of the target user; and
deliver the targeted content via the computing device.
